(19) United States
(12) Patent Application Publication
(10) Pub. No.: US 2025/0335665 A1
(43) Pub. Date: Oct. 30, 2025

(54) SIMULATION DEVICE AND SIMULATION SYSTEM

(71) Applicant: Hitachi, Ltd., Tokyo (JP)

(72) Inventors: Wataru SATOH, Tokyo (JP); Kazuki YOSHIMURA, Tokyo (JP); Taisuke SUGII, Tokyo (JP)

(73) Assignee: Hitachi, Ltd., Tokyo (JP)

(21) Appl. No.: 19/070,013

(22) Filed: Mar. 4, 2025

(30) Foreign Application Priority Data
Apr. 26, 2024 (JP) 2024-072879

(51) Int. Cl. G06F 30/27

(52) U.S. Cl. CPC G06F 30/27

(57) ABSTRACT

A simulation device is a device configured to construct a model and perform a simulation using the model. The simulation device includes a processor and a storage device. The storage device stores, as a library, weighting factor data indicating, by a weighting factor, a relationship between information input by a user and an element of the model and/or a calculation condition. The processor evaluates the information acquired by the input of the user, and constructs a model used for simulation using the weighting factor data stored in the storage device. The processor outputs data indicating information related to the constructed model. The processor performs a simulation based on the constructed model, and outputs data indicating a result of the simulation.

### BACKGROUND OF THE INVENTION

### 1. Field of the Invention

The present invention relates to a simulation device and a simulation system.

### 2. Description of the Related Art

When constructing a simulation model of a mechanical device or a mechanical system, it is necessary to have all information of dimensions, physical property values, arrangements, and connections of equipment as preparation for constructing the model. For example, even in a case of a 3D-CAD model, not all actual elements may be reflected. On the other hand, there is a problem that it takes time to construct a calculation model after preparing all information and data when constructing the model, and executing a calculation.

In addition, in a case where the room temperature and the power consumption in a house or an office building are predicted, a model in which the structure and dimension of the building, physical property values of various members, lighting and electrical products to be a thermal load disposed in the building, and an air conditioner that controls the temperature are disposed is constructed, and a thermal fluid simulation is performed. This makes it possible to predict the power consumption from the air temperature and the flow field in the room, and the amount of heat required for the air conditioner. Here, when an unsteady three-dimensional thermal fluid analysis is performed as a thermal fluid simulation, a model of a building or a room to be evaluated needs to be constructed. At this time, if the dimensions of the room are not known, the region to be calculated cannot be evaluated. Furthermore, unless the air conditioning facility is modeled, the indoor temperature cannot be changed, and the temperature and the power consumption cannot be predicted. As described above, it is necessary to set all the models and analysis conditions when performing analysis, and it takes time to gather these modeling and conditions.

A method is generally used in which a simulation device holds a sample model in advance, selects a sample model close to a simulation desired by an input person, and corrects the selected sample model to be a desired model, or a simulation condition is set by default. However, it is necessary for the input person to grasp a target simulation model in advance. For this purpose, it is necessary to be able to grasp the experience and preliminary examination of the input person with respect to the simulation model, and what kind of element is insufficient, and it is difficult to start the simulation quickly.

With respect to these problems, a method of notifying that there is insufficient information when constructing an analytical model is proposed, where JP 1-204144 A describes “After the insufficient information of the required mathematical expression information and the portion where the insufficient information needs to be set are detected based on the shape information and the mathematical expression information, the detected insufficient information and the setting portion of the insufficient information are displayed on the display device”. Furthermore, a model that constructs a learning model from data and predicts calculation has been studied, and for example, JP 2022-190752 A describes “selecting the plurality of pieces of learning data from a data set, learning the model by using the selected plurality of pieces of learning data, and outputting a predicted value of each of the plurality of pieces of input data by using the model”.

### SUMMARY OF THE INVENTION

### Technical Problem

In JP 1-204144 A, a setting portion of insufficient information necessary for calculation is displayed based on the input shape and numerical information. However, since the calculation is executed after the insufficient information is notified and the appropriate information is input, there is a problem that the calculation result cannot be obtained until the input person inputs the information for which insufficiency has been indicated.

In JP 2022-190752 A, a model enabling a highly accurate inference even with respect to unknown data can be generated by realizing machine learning in consideration of the input data. However, it is necessary to provide representative learning data, and it is not possible to execute simulation and predict a result in a state where the input person does not have data necessary for calculating a result desired to be predicted by simulation. Therefore, there is a problem that it takes time to obtain the simulation model and the calculation result.

As described above, there is a problem in providing a technique capable of constructing a simulation model from limited information, executing a calculation, and obtaining a result even when a structure, dimensions, physical property values, and the like, which are information necessary for executing simulation, are insufficient.

### Solution to Problem

According to a first aspect of the present invention, the following simulation device is provided. A simulation device is a device configured to construct a model and perform a simulation using the model. The simulation device includes a processor and a storage device. The storage device stores, as a library, weighting factor data indicating, by a weighting factor, a relationship between information input by a user and an element of the model and/or a calculation condition. The processor evaluates the information acquired by the input of the user, and constructs a model used for simulation using the weighting factor data stored in the storage device. The processor outputs data indicating information related to the constructed model. In addition, the processor performs a simulation based on the constructed model, and outputs data indicating a result of the simulation.

According to a second aspect of the present invention, the following simulation device is provided. A simulation device is a device configured to construct a model and perform a simulation using the model. The simulation device includes a processor and a communication interface device used for communication. The processor acquires, via the communication interface device, weighting factor data from a device that stores, as a library, weighting factor data indicating, by a weighting factor, a relationship between information input by the user and an element of the model and/or a calculation condition. The processor evaluates the information acquired by the input of the user, and constructs a model used for simulation using the acquired weighting factor data. The processor outputs data indicating information related to the constructed model. In addition, the processor performs a simulation based on the constructed model, and outputs data indicating a result of the simulation.

According to a third aspect of the present invention, the following simulation system is provided. The simulation system includes a simulation device configured to construct a model and perform a simulation using the model; and
a terminal device communicable with the simulation device. the simulation device evaluates information acquired by an input of a user, and constructs a model used for simulation, using weighting factor data indicating, by a weighting factor, a relationship between the information input by the user and an element of the model and/or a calculation condition. The simulation device outputs data indicating information related to the constructed model. In addition, the simulation device performs a simulation based on the constructed model and outputs data indicating a result of the simulation. The terminal device acquires data output from the simulation device, and displays information on the constructed model and information on a result of the simulation.

### Advantageous Effects of Invention

According to the present invention, there is provided a technique capable of constructing a simulation model from limited information, executing calculation, and obtaining a result even when a structure, dimensions, physical property values, and the like, which are information necessary for executing simulation, are insufficient. Note that problems, configurations, and effects other than those described above will be clarified by the following description of DESCRIPTION OF THE PREFERRED EMBODIMENTS.

### BRIEF DESCRIPTION OF THE DRAWINGS

FIG. 1 is a block diagram illustrating an example of a functional configuration of a simulation device according to a first embodiment;

FIG. 2 is a diagram illustrating an example of a display screen of the simulation device according to the first embodiment;

FIG. 3 is a diagram illustrating an example of a model map in the first embodiment;

FIG. 4 is a block diagram illustrating an example of a functional configuration of a simulation device according to a second embodiment;

FIG. 5 is a block diagram illustrating an example of a functional configuration of a simulation device according to a third embodiment;

FIG. 6 is a diagram illustrating an example of a configuration of a simulation device; and

FIG. 7 is a diagram illustrating an example of a configuration of a simulation system.

### DESCRIPTION OF THE PREFERRED EMBODIMENTS

Hereinafter, embodiments of the present invention will be described with reference to the drawings. The embodiments are examples for describing the present invention, and omission and simplification are appropriately made for clarity of description. The present invention can be implemented in various other forms. Unless otherwise specified, each component may be singular or plural.

Positions, sizes, shapes, ranges, and the like of the components illustrated in the drawings may not represent actual positions, sizes, shapes, ranges, and the like in order to facilitate understanding of the invention. Therefore, the present invention is not necessarily limited to the position, size, shape, range, and the like disclosed in the drawings.

Examples of various types of information may be described in terms of expressions such as “table”, “list”, and “queue”, but various types of information may be expressed in a data structure other than these. For example, various types of information such as “XX table”, “XX list”, and “XX queue” may be “XX information”. In describing the identification information, expressions such as “identification information”, “identifier”, “name”, “ID”, and “number” are used, but these can be replaced with each other.

In a case where there is a plurality of components having the same or similar functions, the description may be made with different subscripts given to the same reference numerals. However, in a case where it is not necessary to distinguish the plurality of components, the description may be made with the subscripts omitted.

In the embodiment, a process performed by executing a program may be described. Here, a calculator executes a program by a processor (e.g., CPU, GPU), and performs a process defined by the program using a storage resource (e.g., a memory), an interface device (e.g., a communication port), and the like. Therefore, the subject of the process performed by executing the program may be a processor. Similarly, the subject of the process performed by executing the program may be a controller, a device, a system, a calculator, or a node having a processor. The subject of the process performed by executing the program may be an arithmetic unit, and may include a dedicated circuit that performs a specific process. Here, the dedicated circuit is, for example, a field programmable gate array (FPGA), an application specific integrated circuit (ASIC), a complex programmable logic device (CPLD), or the like.

The program may be installed on the calculator from a program source. The program source may be, for example, a program distribution server or a calculator-readable storage medium. When the program source is a program distribution server, the program distribution server may include a processor and a storage resource that stores a program to be distributed, and the processor of the program distribution server may distribute the program to be distributed to another calculator. Furthermore, in the embodiment, two or more programs may be realized as one program, or one program may be realized as two or more programs.

### First Embodiment

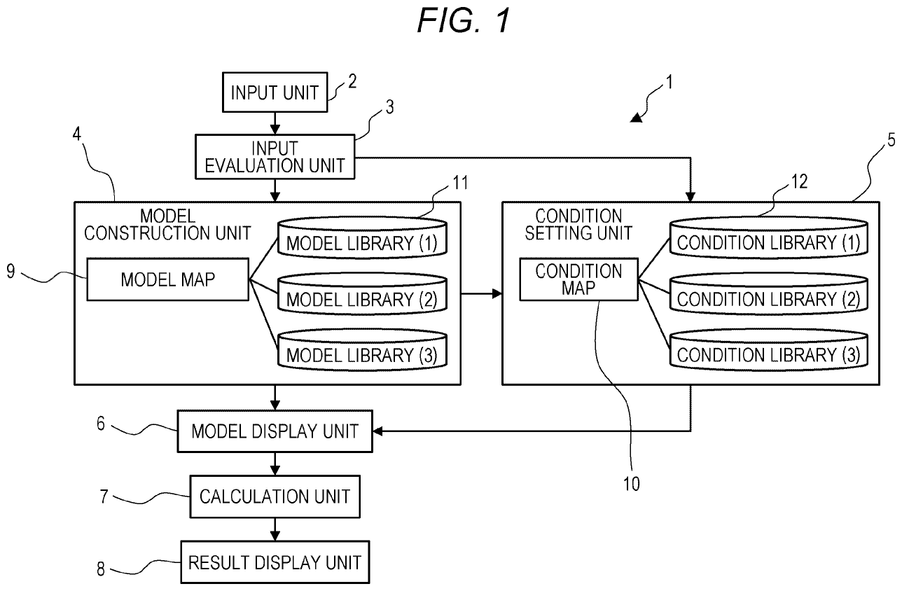

A configuration example of a simulation device will be described with reference to FIG. 1. FIG. 1 is a block diagram illustrating an example of a functional configuration of a simulation device according to a first embodiment. In the following description, the same or similar configurations or functions are denoted by the same reference numerals, and redundant description may be omitted.

A simulation device 1 includes an input unit 2, an input evaluation unit 3, a model construction unit 4, a condition setting unit 5, a model display unit 6, a calculation unit 7, and a result display unit 8. The model construction unit 4 includes a model map 9 and a model library 11, and the condition setting unit 5 includes a condition map 10 and a condition library 12. Note that the model in the present embodiment is a program and data calculated by a computer, and is a mathematical model that obtains an output from an input using a mathematical expression and data.

The input unit 2 performs input of the simulation device. For example, information regarding the content to be simulated is input to the input unit 2 by an input person (user). The input evaluation unit 3 evaluates the input information. The model construction unit 4 and the condition setting unit 5 perform processes related to model construction. The model display unit 6 displays the model. The calculation unit 7 performs calculation such as simulation. The result display unit 8 displays the result of the calculation unit 7.

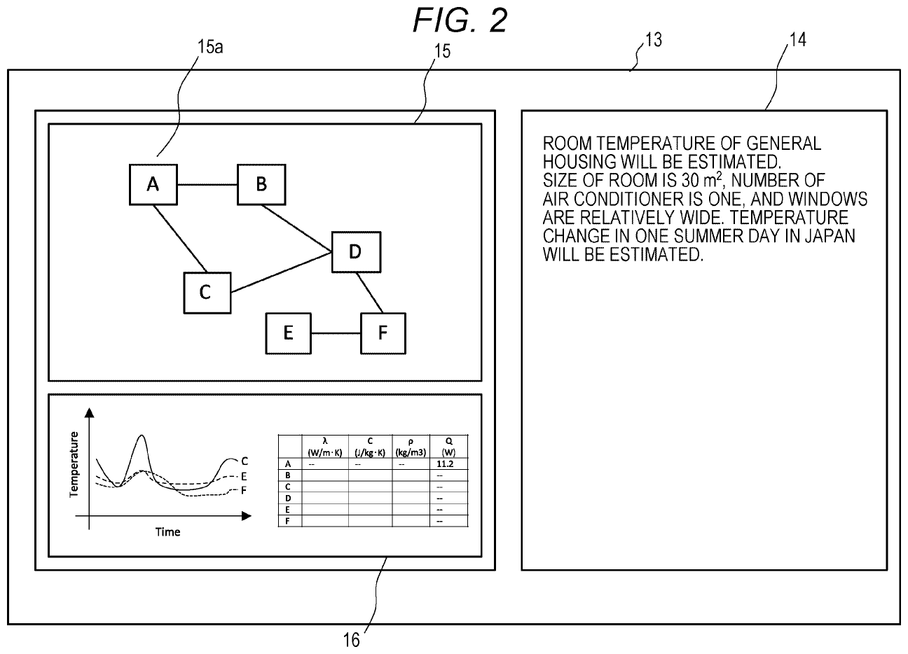

An example of the display screen will be described with reference to FIG. 2. FIG. 2 illustrates an example of a configuration of a display screen 13 when displaying the input unit 2 configured to perform an input of a simulation by the simulation device 1, the model display unit 6, and the result display unit 8 on a display screen of a computer.

The screen input unit 14 of the display screen 13 has, for example, a function of the input unit 2 configured to input a target, a structure, and a condition, on which an input person (user) desires to perform a simulation, with characters. That is, information regarding contents to be simulated is input to the screen input unit 14. Furthermore, the screen model display unit 15 of the display screen 13 has a function of the model display unit 6 configured to display the model constructed by the model construction unit 4 and the condition setting unit 5 from the information input to the screen input unit 14. Furthermore, the screen result display unit 16 of the display screen 13 has a function of the result display unit 8 configured to display the simulation result and the analysis result of the model displayed by the screen model display unit 15.

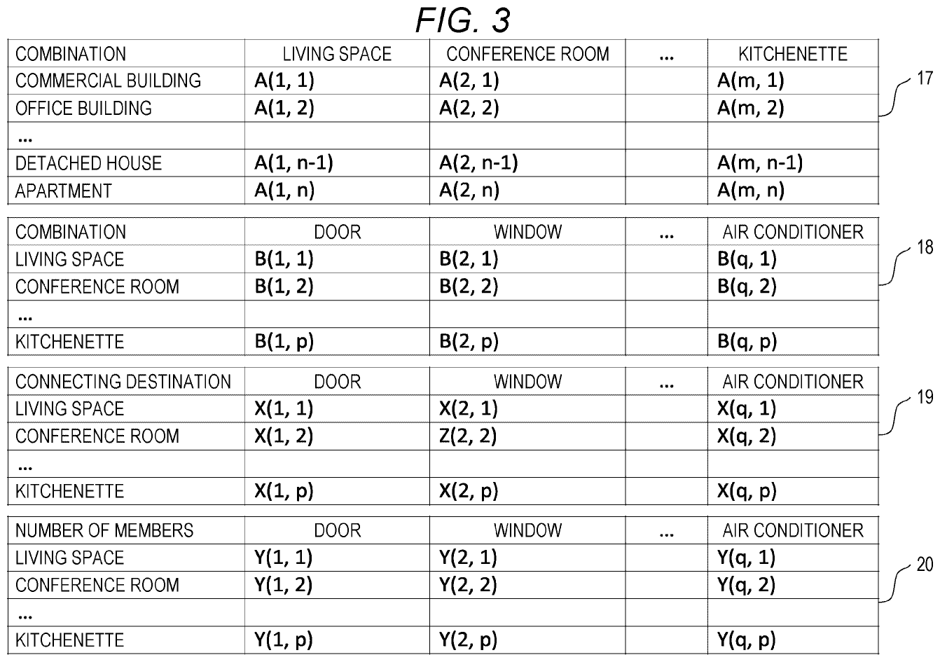

Next, a procedure of simulating temperature prediction of an office building using the simulation device of the first embodiment having these configurations will be described as an example with reference to FIG. 3. FIG. 3 illustrates a configuration of a model map 9 used in the simulation device 1 that realizes the temperature prediction of a building. Here, an example in which the model map 9 is constructed as a table for weighting factors is illustrated.

In the model library 11, a model library (1) includes a library indicating a model structure of a building such as an office building, a commercial building, a detached house, or an apartment, a model library (2) includes a library indicating an internal structure of a room such as a living space, a conference room, a lobby, a rest room, a living room, or a kitchenette, and a model library (3) includes a library of a detailed structure related to equipment such as a door, a window, an air conditioner, a ventilator, a computer, a projector, or a heater. In the case of predicting the temperature, for example, temperature prediction can be performed by using a thermal circuit model. Therefore, elements in which each element is a block of a thermal circuit model are arranged in the library.

The input evaluation unit 3 evaluates an instruction in a language described in the input unit 2. Here, the model map 9 in the model construction unit 4 has a weight table 17 of the model library (2) with respect to the model library (1), and further has a weight table 18 from the model library (2) with respect to the model library (3). Furthermore, the model map 9 includes a table 19 indicating a connection destination of each element of the model library 11 and a table 20 for calculating the number of members of each element. A (i, j), B (i, j), X (i, j), and Y (i, j) described in the table represent weighting factors indicating the respective relationships. Here, i and j are subscripts.

The model construction unit 4 constructs a model by selecting a combination in which the weighting factor derived from the table becomes a maximum using the result of the input evaluation unit 3. In this case, even if all the information in the model map 9 is not input to the input unit 2, an element model necessary for model construction is extracted from the model library 11 and the condition library 12 by the weighting factors stored in advance in the model map 9 and the condition map 10. As a result, the model 15a (in this example, a thermal circuit model) is displayed on the screen model display unit 15, as illustrated in FIG. 2. That is, even if the input information is insufficient or incomplete, the model construction unit 4 and the condition setting unit 5 can construct a model, and the calculation unit 7 can execute calculation using the model. The display of the model 15a by the screen model display unit 15 may be configured to be displayed together with the calculation result of the screen result display unit 16 after the calculation by the calculation unit 7 is executed.

Here, the calculation target is not limited to a building, and is modeling having a physical phenomenon that generally performs simulation, such as a machine, a plant, a piping system, or electricity. For example, a thermal circuit model, a fluid circuit model, and the like are constructed with respect to the simulation regarding the thermal fluid. For simulation related to electricity, an electrical circuit model can be constructed and displayed. The simulation device may display a calculation result of a program for performing another one-dimensional simulation. In addition, the simulation is not limited to one-dimensional simulation, and may be a model that predicts an output from input information using a neural network.

In addition, the model map 9 and the condition map 10 are not limited to a table by a weight function, and may be constructed by a neural network, a mathematical model, or the like. The data (model map 9, condition map 10, etc.) indicating the relationship between the information input by the user and the elements of the model in the library by the weighting factor may be described as weighting factor data. The input evaluation unit 3 may be configured using, for example, a Large Language Model (LLM). Then, based on the evaluation of the input evaluation unit 3, the model map 9 and the condition map 10 can be extracted from the input information input by the input unit 2.

Furthermore, the model element included in the model library 11 is not limited to the thermal circuit model, and may be a model that predicts output data from input data by a physical equation such as a heat conduction equation or a neural network. The condition library 12 stores physical property values, initial conditions, boundary conditions, and the like. For example, conditions such as “spring”, “summer”, “autumn”, and “winter” are saved. However, the simulation device 1 may be configured such that the model construction unit 4 processes these pieces of information similarly to the model library 11.

The number of libraries arranged in each of the model construction unit 4 and the condition setting unit 5 is not limited to three, and one or more libraries may be arranged. The model map 9, the model library 11, the condition map 10, and the condition library 12 do not need to be constructed for each simulation device, and may be saved on a cloud, and the appropriate model construction unit 4 and condition setting unit 5 may be selected by the evaluation of the input evaluation unit 3. The input information is not limited to character information. For example, an image, a figure, or a numerical value may be input, and character information and an image can be evaluated by the input evaluation unit 3 to construct a simulation model.

### Second Embodiment

A second embodiment will be described in detail. The present embodiment shows an example in which the simulation device is provided with an update input unit 21 and a map update unit 22, and the model map 9 and the condition map 10 are updated when the model is updated by giving an instruction to update the model and the calculation condition with respect to the obtained calculation result.

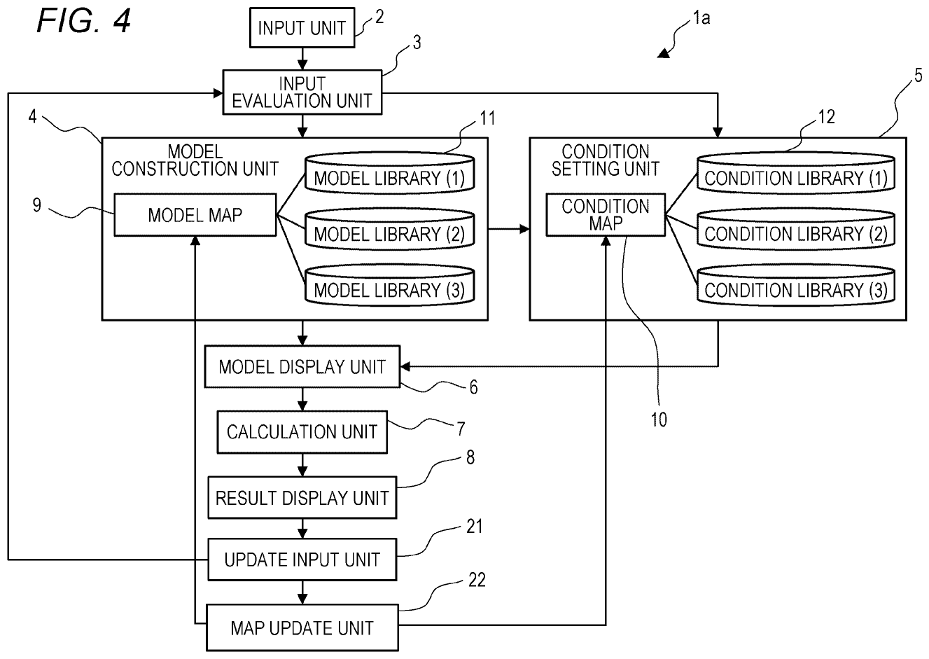

FIG. 4 is a block diagram illustrating an example of a functional configuration of a simulation device 1a according to a second embodiment. The number of models and calculation conditions to be calculated by the model construction unit 4 and the condition setting unit 5 is not limited to one, and the model map 9 and the condition map 10 included in each are not limited to a configuration having a constant value. A correction instruction of a model can be given using the obtained model by providing the update input unit 21. That is, the update input unit 21 may acquire update information regarding the content to be simulated input by the user, the input evaluation unit 3 may evaluate the acquired update information, and the model construction unit 4 and the condition setting unit 5 may perform a process regarding construction of the model to be updated and construct the updated model. Furthermore, a map update unit 22 may be provided, which map update unit 22 may update the model map 9 and the condition map 10 using the simulation model and the calculation result.

Note that, in a case where the result of the simulation is input to the update input unit 21 and the accuracy of the simulation is lower than a predetermined accuracy, an update instruction is output to the map update unit 22, so that the map update unit 22 may adjust (update) the weights of the model map 9 and the condition map 10. Furthermore, the user may check the result display unit 8 and input an update instruction, an adjustment value, and the like, and the map update unit 22 may adjust (update) the weights of the model map 9 and the condition map 10 based on the input of the user. That is, the simulation device 1a may acquire an input related to the update of the weighting factor data by the user and update the weighting factor data.

As a result, even if the expected simulation model and calculation conditions are not set in the instruction of the first simulation by the input person, an update instruction is given to the constructed simulation model, and different simulation results can be obtained. As described above, according to the present embodiment, in addition to the effects of the first embodiment described above, by repeating the simulation and the update instruction, an insufficient condition can be recognized, and a desired simulation result can be approached.

### Third Embodiment

A third embodiment will be described in detail. The present embodiment shows an example in which the model library 11 included in the model construction unit 4 and the condition library 12 included in the condition setting unit 5 have a hierarchical structure in the simulation device.

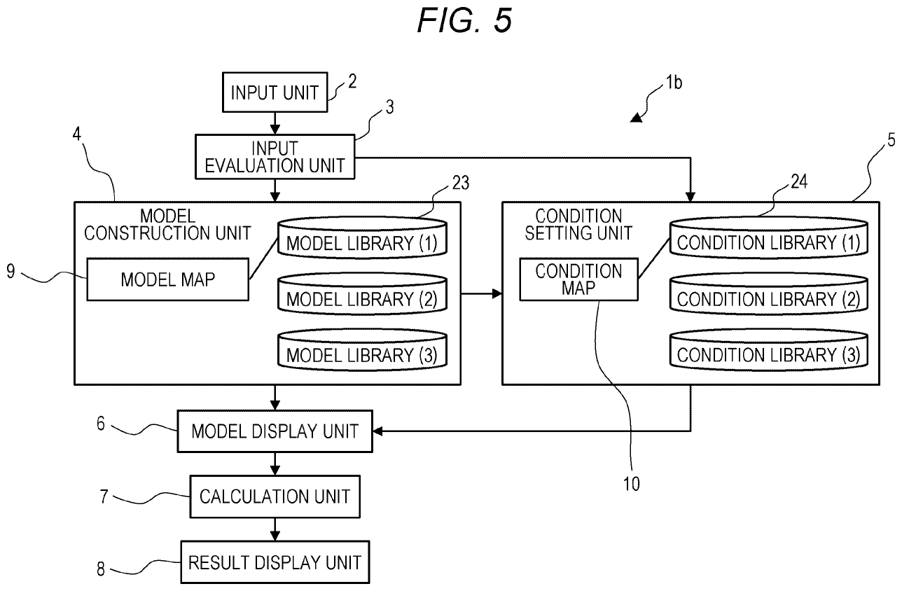

FIG. 5 is a block diagram illustrating an example of a functional configuration of a simulation device 1b according to a third embodiment. When the model library 11 includes a plurality of libraries, a hierarchical model library 23 and a hierarchical condition library 24 may be used. Only the model library 11 may have a hierarchical structure, and the condition library 12 may be a plurality of libraries not having a hierarchical structure. Conversely, only the condition library 12 may be a library having a hierarchical structure.

For example, in the temperature prediction of a building, as described in the first embodiment, among the model libraries, when the model library (1) has a library indicating a model structure of a building such as an office building, a commercial building, a detached house, or an apartment, the model library (2) has a library indicating an internal structure of a room such as a living space, a conference room, a lobby, a rest room, a living room, or a kitchenette, and the model library (3) has a detailed structure related to equipment such as a door, a window, an air conditioner, a ventilator, a computer, a projector, or a heater, elements of the model library (3) are elements for constituting the model library (2), and similarly, elements of the model library (2) are elements for constituting the model library (1), so that modeling can be carried out as a hierarchical structure.

As described above, according to the present embodiment, in addition to the effects of the first embodiment described above, since the model structure to be predicted is organized for each hierarchy, it is possible to suppress the scale of the table of the weight function constituting the model map 9 to be small, and it is possible to further shorten the time until the simulation result is obtained.

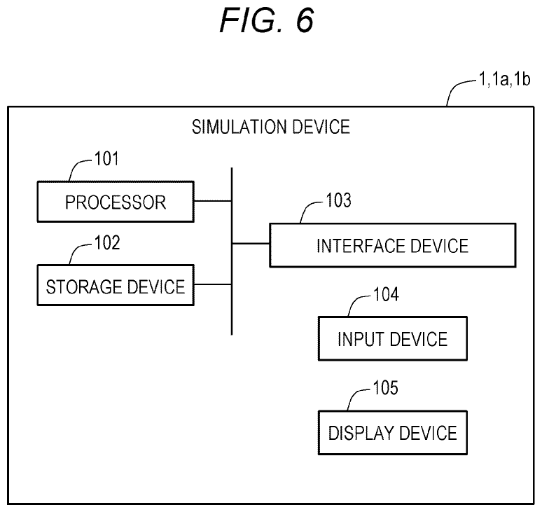

Next, an example of a hardware configuration of the simulation device will be described with reference to FIG. 6. As illustrated in FIG. 6, the simulation device (1, 1a, 1b) includes, by way of example, a processor 101, a storage device 102, an interface device 103, an input device 104, and a display device 105. The processor 101 is connected to the storage device 102 and the interface device 103 via a bus.

The processor 101 is a subject that executes a predetermined process, and can be configured using a semiconductor device. The processor 101 may include, for example, a central processing unit (CPU). The storage device 102 is a device configured to store data, and can be configured using a main storage device (memory), an auxiliary storage device, or the like. The processor 101 can store data such as a program in the main storage device and execute a predetermined process. As an example, the main storage device is configured using a random access memory (RAM). The auxiliary storage device can store data such as a program in a nonvolatile manner. The auxiliary storage device can be configured using a hard disk drive (HDD), a read only memory (ROM), or the like.

The interface device 103 is a device used to exchange data with a connected equipment. The interface device 103 includes, for example, an input/output interface device and a communication interface device.

For example, an input device 104 used by the user for operation may be connected to the input/output interface device, and the operation content of the user may be input. A display device 105 may be connected to the input/output interface device, and the processor 101 may output data used to display information to the display device 105 via the input/output interface device. Note that the processor 101 of the simulation device (1, 1a, 1b) may exchange data with a storage device such as a USB flash drive connected to the input/output interface device. The communication interface device is a device connected to a network and used for communication. The processor 101 may input/output data by communication via the communication interface device.

The input device 104 is, for example, a keyboard, a mouse, or the like, and the operation content of the user is input. The display device 105 is configured using a display, and displays information output by the simulation device (1, 1a, 1b). Note that the input device 104 and the display device 105 may be integrally configured by a touch panel display or the like.

In the simulation device (1, 1a, 1b), the input evaluation unit 3, the model construction unit 4, the condition setting unit 5, and the calculation unit 7 can be realized by using the above-described hardware by way of an example. Furthermore, in the simulation device 1a, the update input unit 21 and the map update unit 22 can be realized by using the above-described hardware by way of an example.

The input evaluation unit 3 can be realized, for example, by a processor storing data such as a program in a memory and performing data processing.

The model construction unit 4 can be realized, for example, by a processor storing data such as a program in a memory and performing data processing. Note that the model map 9, the model library 11, and the hierarchical model library 23 can be realized by using, for example, a storage device.

The condition setting unit 5 can be realized, for example, by a processor storing data such as a program in a memory and performing data processing. Note that the condition map 10, the condition library 12, and the hierarchical condition library 24 can be realized by using, for example, a storage device.

The calculation unit 7 can be realized, for example, by a processor storing data such as a program in a memory and performing data processing.

The update input unit 21 and the map update unit 22 can be realized, for example, by a processor storing data such as a program in a memory and performing data processing.

Furthermore, in the simulation device (1, 1a, 1b), the input unit 2, the model display unit 6, and the result display unit 8 can be realized by using the above-described hardware by way of an example.

The input unit 2 can be realized, for example, by a processor storing data such as a program in a memory and performing data processing. Here, the input unit 2 may be realized by using an interface device, and the processor may control the interface device. Furthermore, the input unit 2 can be realized by using an input device connected to the interface device. Furthermore, the input unit 2 can be realized by using a display device connected to the interface device.

The model display unit 6 and the result display unit 8 can be realized, for example, by a processor storing data such as a program in a memory and performing data processing. Here, the model display unit 6 and the result display unit 8 may be realized by using an interface device, and the processor may control the interface device. In addition, the model display unit 6 and the result display unit 8 can be realized by using a display device connected to the interface device. This display device can display a display screen 13.

The simulation device (1, 1a, 1b) may acquire data from an external device including a storage via the communication interface device and perform processing. This device may store, for example, the model map 9, the condition map 10, the model library 11, the condition library 12, the hierarchical model library 23, the hierarchical condition library 24, and the like.

Some of the simulation devices (1, 1a, 1b) may be arranged in the cloud. A device including the storage may be disposed in the cloud, and the processor may obtain, in the process, data from the device via the communications interface device. This device may store, for example, the model map 9, the condition map 10, the model library 11, the condition library 12, the hierarchical model library 23, the hierarchical condition library 24, and the like.

In addition, the simulation device 1a may update data stored in an external device via the communication interface device.

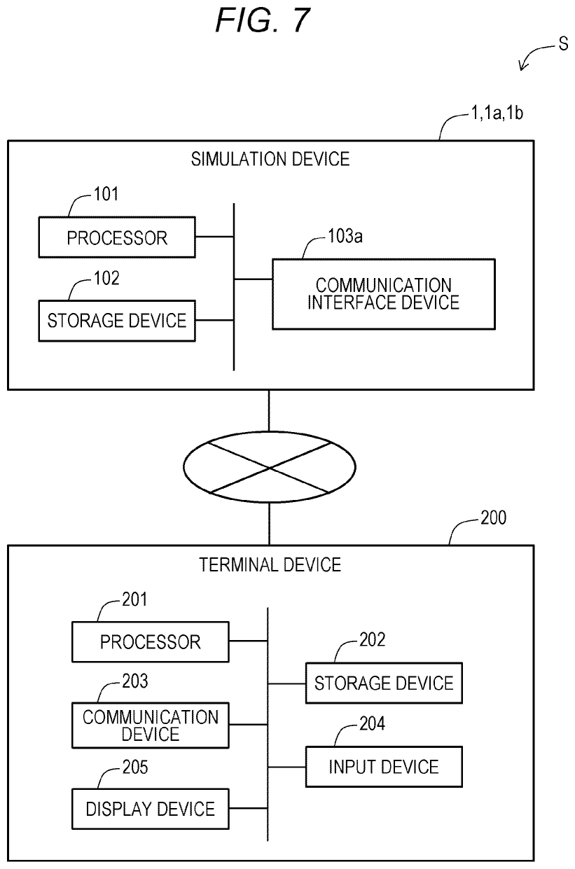

FIG. 7 illustrates an example of a configuration of a system including the simulation device. The system S (simulation system) includes the simulation device (1, 1a, 1b) and a terminal device 200. The simulation device (1, 1a, 1b) is configured as a server, and includes, by way of an example, a processor 101, a storage device 102, and a communication interface device 103a. The system S may be constructed in a local area network (LAN). For example, in the system S, the simulation device (1, 1a, 1b) and the terminal device 200 may be installed in the same facility. However, by way of an example, some of the simulation devices (1, 1a, 1b) may be arranged in the cloud.

The communication interface device 103a is a device connected to a network and used for communication. The processor 101 may input/output data by communication via the communication interface device 103a. For example, the processor 101 may acquire data from the terminal device 200 or the like via communication. Furthermore, the processor 101 may acquire data from an external device including a storage via the communication interface device 103a and perform processing. This device may store, for example, the model map 9, the condition map 10, the model library 11, the condition library 12, the hierarchical model library 23, the hierarchical condition library 24, and the like. In addition, the simulation device 1a may update data stored in an external device via the communication interface device 103a.

The terminal device 200 is used by a user who uses the simulation device (1, 1a, 1b). The terminal device 200 is configured as a computer device capable of communicating with the simulation device (1, 1a, 1b), and includes, by way of an example, a processor 201, a storage device 202, a communication device 203, an input device 204, and a display device 205.

The processor 201 is a subject that executes a predetermined process, and can be configured using a CPU or the like. The storage device 202 can be configured using a main storage device (memory) and an auxiliary storage device. The communication device 203 is an interface device used for communication. The input device 204 is a device used to input the operation content of the user. The user may input information, settings, weight adjustment values, and the like regarding the content to be simulated, and the simulation device (1, 1a, 1b) may acquire the content input by the user and perform processing. The display device 205 is configured using a display, and can display information. The simulation device (1, 1a, 1b) may transmit data used to display information to be provided to the user, and the processor 201 of the terminal device 200 may display the information on the display device 205 using the data acquired from the simulation device (1, 1a, 1b). Note that the input device 204 and the display device 205 may be integrally configured by a touch panel display or the like.

The system S may include a single terminal device 200. Furthermore, the system S may include a plurality of terminal devices 200. Moreover, the configuration of the terminal device 200 is an example, and may be changed as appropriate.

Note that the input unit 2, the model display unit 6, and the result display unit 8 may be realized using the configuration of the terminal device 200.

The system S is a system connected by a LAN, and the simulation device may acquire data from the storage device 102 included in the simulation device and perform processing. Here, the storage device 102 may store, for example, the model map 9, the condition map 10, the model library 11, the condition library 12, the hierarchical model library 23, the hierarchical condition library 24, and the like. In addition, the simulation device may be provided with an input/output interface device, and may acquire data from a storage device connected to the input/output interface device and perform processing. For example, similar data (9, 10, 11, 12, 23, 24) may be stored in the storage device. In addition, the simulation device 1a may update data stored in the storage device.

As an example, even if the structure, dimensions, physical property values, and the like, which are information necessary for executing the simulation, are insufficient, the simulation device is configured to extract elements necessary for executing the simulation from the model library and the condition library using the model map and the condition map and automatically construct the simulation model.

As a result, it is not necessary to prepare all the conditions and data necessary for executing the simulation before constructing the model, and it is possible to construct the simulation model from the limited information possessed by the input person, execute calculation, and obtain a result. In addition, even if the information is insufficient, the model and the calculation result can be quickly presented by performing prediction from the input information and constructing the model, and the time can be shortened. In addition, the semi-automation of the model creation can reduce the cost, and hence there is an economic advantage.

The simulation device can be configured using, for example, an input device, a model library having a physical equation, a calculation model, and the like, a model map configured to evaluate a combination in the model library, a condition library having a physical property value, an initial condition, a boundary condition, and the like, a condition map configured to evaluate a combination in the condition library, a calculation unit configured to calculate with the constructed model and condition, and a display device configured to display the constructed model and calculation result.

Then, based on the incomplete input information, a model to be combined is called out from various libraries by using the model map, and a boundary condition to be applied to a model constructed by using the condition map, a calculation condition to be combined, and the like are called out from the condition library, whereby a model that can be calculated can be constructed, and a calculation result of the constructed model can be displayed.

For example, when the user views the display result, the information (i.e., information on a target, a structure, and a condition for which simulation is desired to be performed.) input by the user is updated, and new information is input, so that the analysis model and the analysis result can be gradually approached to the desired model and result.

Furthermore, by updating the model map and the condition map using the input information and the analysis result, it is possible to obtain construction of the analysis model and display of the analysis result intended by the input person (user).

According to the embodiment, as an example, the following simulation device is provided.

(1) Provided is a simulation device including an input unit configured to accept an input of a calculation instruction and an input evaluation unit configured to evaluate the calculation instruction, and configured to perform a simulation based on an instruction of the input evaluation unit, the simulation device including: a model library, a model construction unit configured from a model map indicating, by a weighting factor, a relationship between the calculation instruction and the model library, a condition library, a condition setting unit configured from the condition map indicating, by a weighting factor, a relationship between the calculation instruction, the model construction unit, and the condition library, a model display unit configured to display a calculation model constructed by the model construction unit and the condition setting unit, a calculation unit configured to perform a simulation using the calculation model, and a result display unit configured to output a result obtained by the calculation unit.

(2) The simulation device according to (1), further including an update input unit, where an update instruction of the update input unit is evaluated by the input evaluation unit, and a calculation model is updated.

(3) The simulation device according to (2), further including a map update unit, where a calculation result obtained from the calculation unit is compared with an update instruction input to the update input unit, and the model map and the condition map are updated.

(4) In the simulation device according to any one of (1) to (3), where the model library and the condition library have a hierarchical structure.

(5) The simulation device according to any one of (1) to (4), where the input evaluation unit includes a large language model.

Although the embodiments have been described above, the present invention is not limited to the above-described embodiments, and various modifications and equivalent configurations within the scope of the appended claims are included. For example, the above-described embodiments have been described in detail for the sake of easy understanding of the present invention, and the present invention is not necessarily limited to those having all the described configurations. In addition, for example, a part of the configuration of the embodiment may be added, deleted, or replaced with another configuration.

What is claimed is:

1. A simulation device configured to construct a model and perform a simulation using the model, the simulation device comprising:
a processor; and
a storage device;
wherein the storage device
stores, as a library, weighting factor data indicating, by a weighting factor, a relationship between information input by a user and an element of a model and/or a calculation condition; and
the processor is configured to:
evaluate information acquired by an input of the user, and construct a model used for a simulation using the weighting factor data stored in the storage device,
output data indicating information related to the constructed model, and
perform a simulation based on the constructed model and output data indicating a result of the simulation.

2. The simulation device according to claim 1, wherein
the processor is further configured to
evaluate updated input information, and construct an updated model using the weighting factor data stored in the storage device.

3. The simulation device according to claim 1, wherein
the processor is further configured to
acquire an input of the user related to update of the weighting factor data, and update the weighting factor data stored in the storage device.

4. The simulation device according to claim 1, wherein
the library has a hierarchical structure.

5. The simulation device according to claim 1, wherein
the processor is further configured to
evaluate information based on a large language model.

6. A simulation device configured to construct a model and perform a simulation using the model, the simulation device comprising:
a processor; and
a communication interface device used for communication;
wherein the processor is configured to:
acquire, via the communication interface device, weighting factor data from a device that stores, as a library, the weighting factor data indicating, by a weighting factor, a relationship between information input by a user and an element of a model and/or a calculation condition;
evaluate information acquired by an input of the user, and construct a model used for a simulation using the acquired weighting factor data,
output data indicating information related to the constructed model, and
perform a simulation based on the constructed model and output data indicating a result of the simulation.

7. A simulation system comprising:
a simulation device configured to construct a model and perform a simulation using the model; and
a terminal device communicable with the simulation device;
wherein the simulation device is configured to:
evaluate information acquired by an input of a user, and construct a model used for simulation, using weighting factor data indicating, by a weighting factor, a relationship between the information input by the user and an element of the model and/or a calculation condition,
output data indicating information related to the constructed model, and
perform a simulation based on the constructed model and output data indicating a result of the simulation; and
the terminal device is configured to:
acquire data output from the simulation device, and
display information on the constructed model and information on a result of the simulation.

8. The simulation system according to claim 7, wherein
the simulation system
is a system connected in a local area network, and
the simulation device
acquires the weighting factor data from a storage device included in the simulation device or a storage device connected to an input/output interface device included in the simulation device.
